(19) United States
(12) Patent Application Publication
(10) Pub. No.: US 2022/0010877 A1
(43) Pub. Date: Jan. 13, 2022

(54) PRESSURE REGULATOR VALVE ASSEMBLY FOR IMPROVED FLUID FLOW IN AUTOMATIC TRANSMISSION

(71) Applicant: Sonnax Transmission Company, Bellows Falls, VT (US)

(72) Inventors: John Varvayanis, Bellows Falls, VT (US); Maura J. Stafford, Warner Robins, GA (US); James A. Dial, Springfield, MO (US)

(21) Appl. No.: 17/372,901

(22) Filed: Jul. 12, 2021

Related U.S. Application Data
(60) Provisional application No. 63/051,066, filed on Jul. 13, 2020.

(51) Int. Cl. F16H 61/02; F16H 61/00

(52) U.S. Cl. CPC F16H 61/0276; F16H 2061/0279; F16H 61/0009

(57) ABSTRACT

A pressure regulator valve assembly for an automatic transmission includes a valve body, a valve chamber within the valve body, a valve piston disposed within the valve chamber, the valve piston having a valve channel, and a check valve disposed within the valve channel, the check valve is operable to permit fluid flow in the valve channel in a first direction and substantially prevent fluid flow in the valve channel in a second direction opposite to the first direction. An automatic transmission may include the pressure regulator valve assembly between a hydraulic pump and a torque converter, the pressure regulator valve assembly configured to control fluid flow between the hydraulic pump and the torque converter.

### CROSS-REFERENCE TO RELATED APPLICATION DATA

This application claims the benefit of and priority to Provisional U.S. patent application Ser. No. 63/051,066,filed Jul. 13, 2020, titled PRESSURE REGULATOR VALVE ASSEMBLY FOR IMPROVED FLUID FLOW IN AUTOMATIC TRANSMISSION, the disclosure of which is incorporate herein in its entirety.

### BACKGROUND

The following description relates generally to an automatic transmission for a vehicle, for example, a pressure regulator valve assembly in an automatic transmission configured for improved fluid flow to a torque converter and/or a fluid cooler.

FIG. 1 is a schematic diagram showing an example of a known automatic transmission 100, including hydraulic fluid flow diagram when the automatic transmission 100 is in PARK/NEUTRAL. The known automatic transmission 100 generally includes a hydraulic pump 102, a torque converter 104, a fluid cooler 106 and a pressure regulator valve assembly 110. The pressure regulator valve assembly 110 is configured to control fluid flow from the hydraulic pump 102 to the torque converter 104 and the fluid cooler 106.

The hydraulic pump 102 is typically operated based on operation of a vehicle engine. For example, the hydraulic pump 102 typically pumps a lower volume of fluid when the vehicle engine is operated in a relatively low RPM range, such as when the automatic transmission is in PARK or NEUTRAL, or in some instances, in DRIVE. Accordingly, the torque converter 104 typically receives less fluid when the vehicle engine is operating in the relatively low RPM range. Conversely, the hydraulic pump 102 typically pumps a high volume of fluid when the vehicle engine is operated in a relatively high RPM range, such as when the automatic transmission is in DRIVE. Accordingly, the torque converter 104 typically receives more fluid when the vehicle engine is operating in the relatively high RPM range. Thus, the hydraulic pump 102 may provide fluid to the pressure regulator valve assembly 110 within a relatively low pressure range when the automatic transmission is in PARK or NEUTRAL, and in some instances, DRIVE, and within a relatively high pressure range when the automatic transmission is in DRIVE. In the known automatic transmission, instances of low volume pressure or low volume fluid flow may lead to an insufficient volume of fluid provided to the torque converter 104, a lube circuit of the automatic transmission 100, and/or the fluid cooler 106. An insufficient volume of fluid may cause, for example, overheating, stall and/or lube failures.

Chrysler RFE series automatic transmissions (45RFE, 545RFE, 65RFE, 66RFE, 68RFE) include a torque converter, hydraulic pump, fluid cooler and pressure regulator valve assembly as described above in the known transmission. The Chrysler RFE series transmissions may be referred to herein collectively as an original equipment transmission, or “OE transmission.” Similarly, components of the OE transmission may be prefaced with the “OE” terminology. For example, the pressure regulator valve assembly of the OE transmission may be referred to herein as an OE pressure regulator valve assembly. As used herein, the OE transmission is the transmission installed in a vehicle by the original manufacturer during assembly of the vehicle.

FIG. 2 is a cross-sectional diagram illustrating an example of an OE pressure regulator valve assembly 210 in a CLOSED condition, and FIG. 3 is a cross-sectional diagram illustrating an example of the OE pressure regulator valve assembly 210 in an OPEN condition. Referring to FIGS. 2 and 3, the OE pressure regulator valve assembly 210 includes a valve body 212 having a valve chamber 214 and a valve piston 216 disposed in the valve chamber 214. The OE pressure regulator valve assembly 210 receives fluid from the hydraulic pump through an inlet 218 and can provide fluid to the torque converter and/or fluid cooler through an outlet 220. The valve piston 216 is movable between a CLOSED position (FIG. 2) corresponding to the CLOSED condition of the OE pressure regulator valve assembly 210 and an OPEN position (FIG. 3) corresponding to the OPEN condition of the OE pressure regulator valve assembly 210. The valve piston 216 is in the CLOSED position when fluid pressure from the hydraulic pump is relatively low. In the CLOSED position, the valve piston 216 restricts fluid flow between the inlet 218 and the outlet 220 as indicated by OE flow path OE1 in FIG. 2. The valve piston 216 may move in the direction indicated by arrow Al to the OPEN position, as shown in FIG. 3, in response to a relatively high fluid pressure provided from the hydraulic pump. In the OPEN position, fluid flow is permitted between the inlet 218 and the outlet 220 along a recessed portion of the valve piston 216, as indicated by OE flow path OE1 in FIG. 3.

FIG. 4 is an enlarged cross-sectional diagram illustrating the OE pressure regulator valve assembly 210 at DETAIL C of FIG. 2. A fluid bypass channel 224 fluidically connects the inlet 218 and the outlet 220 when the valve piston 216 is in the CLOSED position. In this manner, some fluid flow may be accommodated through the OE pressure regulator valve assembly 210 along OE flow path OE2 when the valve piston 216 is in the CLOSED position, to provide fluid to the torque converter and the fluid cooler.

However, a width of the fluid bypass channel 224 is relatively small and may not allow a sufficient volume of fluid flow to torque converter and/or the fluid cooler when the valve piston 216 is in the CLOSED position. Insufficient fluid in the torque converter may cause accelerated or excessive wear of the torque converter and/or negatively affect performance of the automatic transmission. In addition, when the vehicle engine and the hydraulic pump are turned off, the fluid backflows or drains from the torque converter through the outlet 220, the fluid bypass channel 224 and the inlet 218. Thus, an insufficient volume of fluid may be stored in the torque converter upon vehicle engine startup, which may delay engagement of transmission components.

Aftermarket efforts have been made to improve fluid flow to the torque converter in the OE transmission. For example, FIG. 5 is a cross-sectional diagram illustrating an example of a known aftermarket pressure regulator valve assembly 510 for the OE transmission. The aftermarket pressure regulator valve assembly 510 is a modified version of the OE pressure regulator valve assembly 210 described above and shown in FIGS. 2-4, and generally includes the same components. The aftermarket pressure regulator valve assembly 510 is formed by performing an aftermarket modification to the OE pressure regulator valve assembly 210. However, the aftermarket pressure regulator valve assembly 510 further includes a second bypass channel 524 fluidically connecting the inlet 218 to the outlet 220. Thus, fluid flow may be accommodated through the aftermarket pressure regulator valve assembly 510 along aftermarket (AM) flow path AM1 when the valve piston 216 is in the CLOSED position. The second bypass channel 524 may be formed by drilling a hole in the valve body 212 between the inlet 218 and the outlet 220 of the OE pressure regulator valve assembly 210. Accordingly, an additional volume of fluid may be provided to the torque converter via the second bypass channel 524 to supplement or replace fluid provided via the first bypass channel 224. However, the second bypass channel 524 may exacerbate the backflow or draining of fluid from the torque converter when the vehicle engine is turned off.

Accordingly, it is desirable to provide a pressure regulator valve assembly configured to improve fluid flow to a torque converter and fluid cooler of an automatic transmission and decrease fluid backflow from the torque converter.

### SUMMARY

According to an embodiment, a pressure regulator valve assembly for an automatic transmission includes a valve body, a valve chamber within the valve body, a valve piston disposed within the valve chamber, the valve piston having a valve channel, and a check valve disposed within the valve channel. The check valve is operable to permit fluid flow in the valve channel in a first direction and substantially prevent fluid flow in the valve channel in a second direction opposite to the first direction.

In embodiments, the valve body may include a fluid inlet and a fluid outlet. The fluid inlet and the fluid outlet may be fluidically connected via the valve channel. The valve channel includes a first opening and a second opening. The first opening is at least partially aligned with the fluid inlet and the second opening is at least partially aligned with the fluid outlet.

According to another embodiment, an automatic transmission includes a hydraulic pump, a torque converter, and pressure regulator valve assembly disposed between the hydraulic pump and the torque converter. The pressure regulator valve assembly is configured to control fluid flow between the hydraulic pump and the torque converter. The pressure regulator valve assembly includes a valve body, a valve chamber within the valve body. a valve piston disposed within the valve chamber, the valve piston having a valve channel, and a check valve disposed within the valve channel. The check valve is operable to permit fluid flow in the valve channel in a first direction from the hydraulic pump to the torque converter and substantially prevent fluid flow in the valve channel in a second direction from the torque converter to the hydraulic pump.

In embodiments, the valve body may include a fluid inlet configured to receive fluid flow from the hydraulic pump and a fluid outlet configured to permit fluid flow to the torque converter. In an embodiment, the fluid inlet and the fluid outlet are fluidically connected via the valve channel. The valve channel may include a first opening and a second opening. The first opening may be at least partially aligned with the fluid inlet and the second opening may be at least partially aligned with the fluid outlet.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a schematic diagram illustrating an example of a known automatic transmission including hydraulic fluid flow paths when the automatic transmission is in PARK/NEUTRAL;

FIG. 2 is a cross-sectional diagram illustrating an example of an OE pressure regulator valve assembly for an OE transmission in a CLOSED condition;

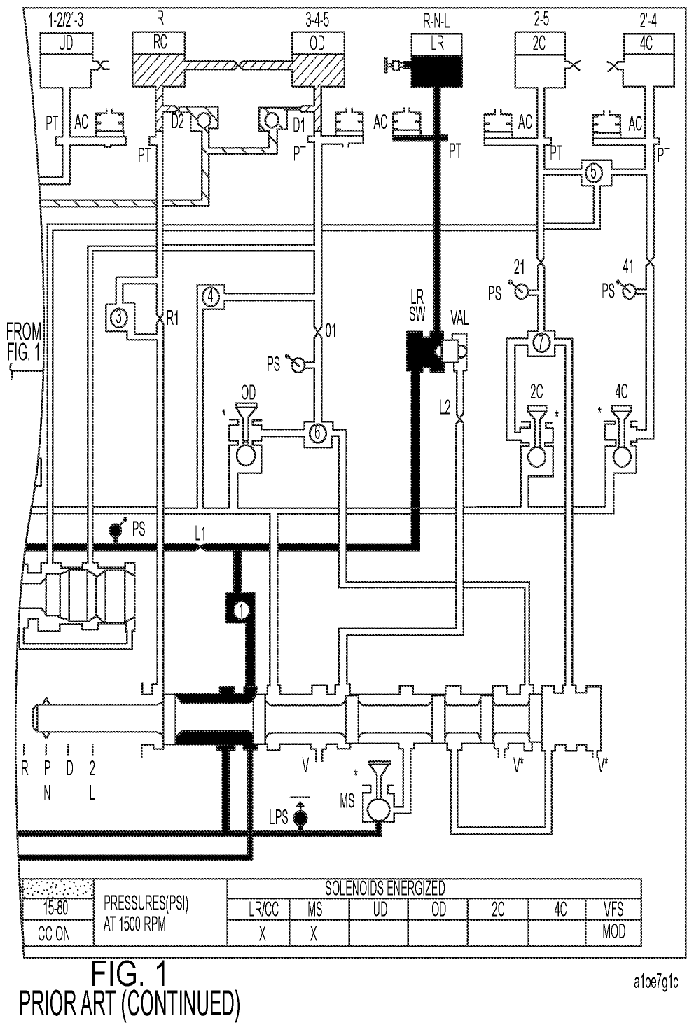

FIG. 3 is a cross-sectional diagram illustrating an example of the OE pressure regulator valve assembly of FIG. 2 in an OPEN condition;

FIG. 4 is an enlarged cross-sectional diagram illustrating the OE pressure regulator valve assembly at DETAIL C of FIG. 2;

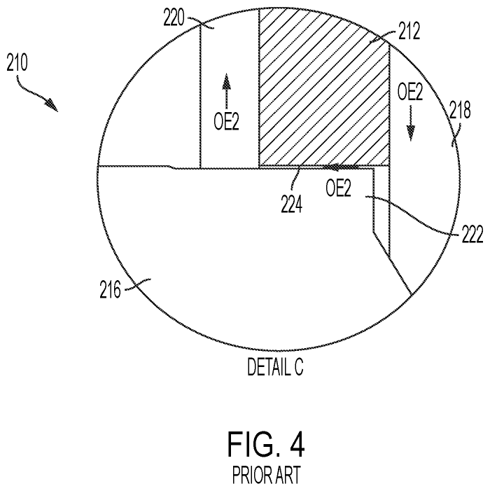

FIG. 5 is a cross-sectional diagram illustrating an example of a known aftermarket pressure regulator valve assembly for an OE transmission;

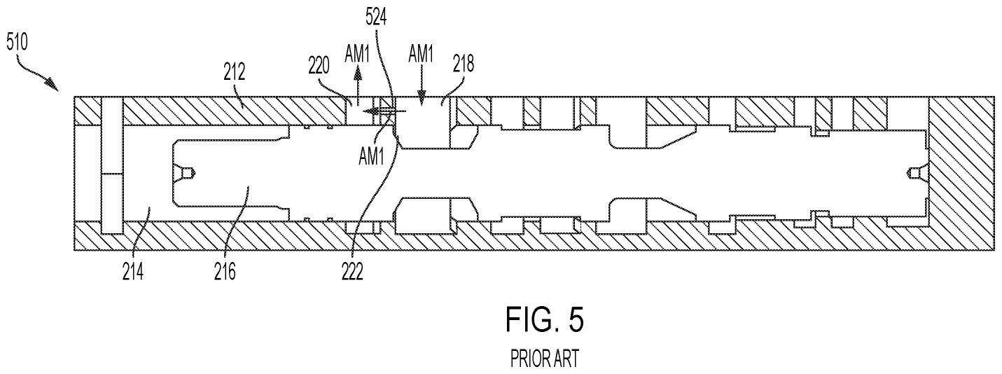

FIG. 6 is a cross-sectional diagram illustrating a pressure regulator valve assembly of an automatic transmission according to an embodiment;

FIG. 7 is another cross-sectional diagram of the pressure regulator valve assembly of FIG. 6, according to an embodiment; and

FIG. 8 is schematic diagram illustrating an automatic transmission having a pressure regulator valve assembly according to an embodiment.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

In embodiments herein, a pressure regulator valve assembly may be disposed between a hydraulic pump and a torque converter of an automatic transmission for a vehicle. The pressure regulator valve assembly may be operable to control fluid flow between the hydraulic pump and the torque converter and fluid cooler. The fluid may be, for example, a lubricant and/or coolant, such as a known, suitable, automatic transmission fluid. The pressure regulator valve assembly of the embodiments herein may be used in the OE transmission described above, i.e., the Chrysler RFE series automatic transmissions (45RFE, 545RFE, 65RFE, 66RFE, 68RFE), and may replace the OE pressure regulator valve assembly 210 or an aftermarket modified pressure regulator valve assembly 510 (i.e., the aftermarket modified OE pressure regulator valve assembly 210) used in the OE transmission.

In general, the hydraulic pump operates based on operation of a vehicle engine. With the vehicle engine turned off, fluid pressure provided to the pressure regulator valve assembly is less than a first fluid pressure. With the vehicle engine operating in a relatively low RPM range, for example, with the automatic transmission in PARK or NEUTRAL (or in some instances, DRIVE), fluid pressure provided to the pressure regulator valve assembly by the hydraulic pump may be greater than the first fluid pressure and less than a second fluid pressure. With the vehicle engine operating a relatively high RPM Range, for example, with the automatic transmission in DRIVE, fluid pressure provided to the pressure regulator valve assembly may be greater than the second fluid pressure.

In an example of an implementation of the pressure regulator valve assembly according to embodiments herein, a valve piston of the pressure regulator valve assembly includes a valve channel. A check valve is disposed in the valve channel. The valve piston may be in a CLOSED position and the check valve may be in a check valve CLOSED position when the fluid pressure provided to the pressure regulator valve assembly is less than the first fluid pressure. The valve piston may be in the CLOSED position and the check valve may be in a check valve OPEN position when the fluid pressure provided to the pressure regulator valve assembly is greater than the first fluid pressure and less than the second fluid pressure. The valve piston may be in an OPEN position when the fluid pressure provided to the pressure regulator valve assembly is greater than the second fluid pressure.

As described in embodiments further below, with the valve piston in a CLOSED position and the check valve in a check valve OPEN position, fluid flow in a first direction from the hydraulic pump to the torque converter and fluid cooler through the pressure regulator valve assembly may be accommodated through the valve channel. Additionally, with the valve piston in the CLOSED position and the check valve in the check valve CLOSED position, fluid flow in a second direction from the torque converter to the hydraulic pump through the pressure regulator valve assembly, i.e., backflow, may be substantially prevented by the check valve.

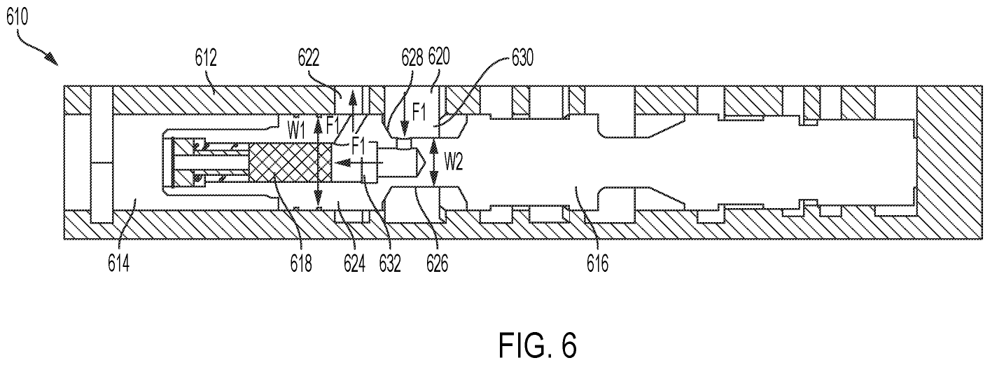

FIG. 6 is a cross-sectional diagram illustrating a pressure regulator valve assembly 610 of an automatic transmission according to an embodiment. The pressure regulator valve assembly 610 includes a valve body 612, a valve chamber 614 within the valve body 612, a valve piston 616 disposed in the valve chamber 614 and a check valve 618 operably connected to the valve piston 616. In an embodiment, the valve piston 616 and the valve chamber 614 may both be cylindrical or other suitable shapes. The valve body 612 may be any suitable shape, for example, cylindrical or substantially cylindrical. The valve body 612 may include a fluid inlet 620 and a fluid outlet 622.

The valve chamber 614 may be fluidically connected to the hydraulic pump via the fluid inlet 620. In addition, the valve chamber 614 may be fluidically connected to the torque converter via the fluid outlet 622. Thus, the valve chamber 614 may receive fluid from the hydraulic pump through the fluid inlet 620, and fluid may be provided from the valve chamber 614 to the torque converter through the fluid outlet 622.

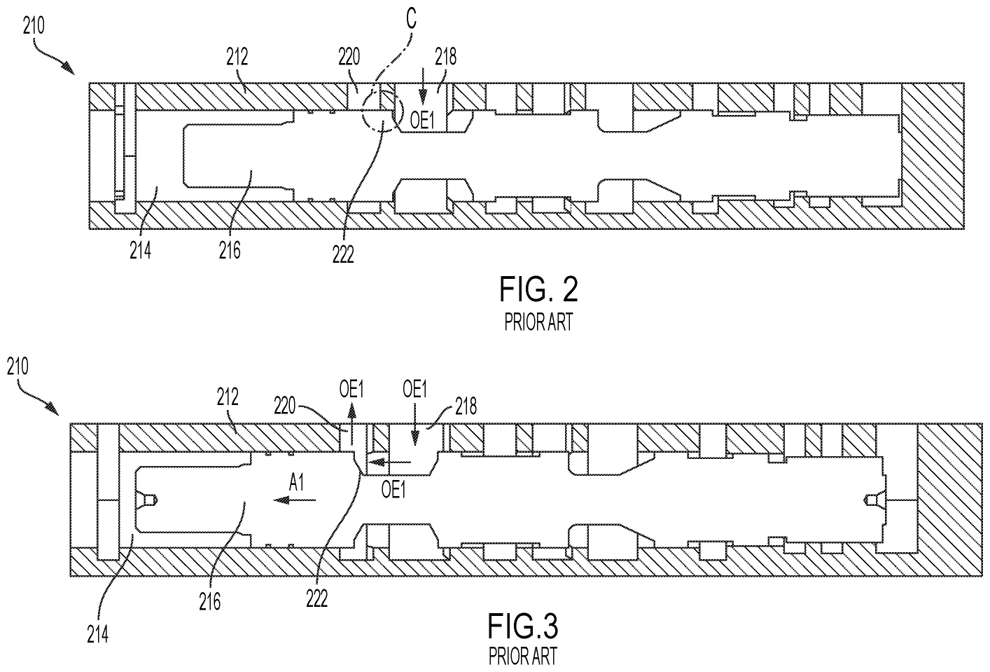

In an embodiment, the valve piston 616 may be moved between the CLOSED position and the OPEN position in the same manner as the valve piston 216 of the OE pressure regulator valve assembly 210. For example, the valve piston 616 may be in the CLOSED position as shown in FIG. 6, and may be moved to the OPEN position, similar to the valve piston 216 shown in FIG. 3, in response to an increase in fluid pressure provided by the hydraulic pump to the pressure regulator valve assembly 610. For example, the valve piston 616 may move from the CLOSED position to the OPEN position in response to the fluid pressure increasing above the second fluid pressure. Conversely, the valve piston 616 may move from the OPEN position to the CLOSED position in response to the fluid pressure decreasing below the second fluid pressure.

The valve piston 616 may have a first section 624 having a first width W1 and a second section 626 having a second width W2. The second width W2 may be less than the first width W1. In an embodiment, the valve piston 616 may include a shoulder 628 formed by the difference between the first width W1 and the second width W2. In addition, the second section 626, having the second width W2, may form a recess 630 on an outer periphery of the valve piston 616. In the CLOSED position, the recess 630 may be at least partially aligned with the fluid inlet 620 and the shoulder 628 may be disposed between the fluid inlet 620 and the fluid outlet 622. The width W1 of the first section 624 may be substantially equal to, or slightly less than a width of the valve chamber 614. Accordingly, in the CLOSED position, the shoulder 628 may substantially limit or prevent fluid flow between the fluid inlet 620 and the fluid outlet 622 along an outer periphery of the valve piston 616.

In the OPEN position, the valve piston 616 may be moved so that the recess 630 is at least partially aligned with the fluid inlet 620 and the fluid outlet 622, similar to the valve piston 216 of the OE pressure regulator valve assembly 210 shown in FIG. 3.

In an embodiment, the valve piston 616 may further include a valve channel 632. The valve channel 632 may be disposed at least partially within the valve piston 616. The valve channel 632 is configured to receive fluid from the fluid inlet 620. The valve channel 632 is also configured to permit fluid flow to the fluid outlet 622. Accordingly, with the valve piston 616 in the CLOSED position, fluid flow may be permitted between the fluid inlet 620 and the fluid outlet 622 through the valve channel 632.

The check valve 618 may be disposed in the valve channel 632 and may control fluid flow through the valve piston 616 when the valve piston 616 is in the CLOSED position. In the check valve OPEN position, shown in FIG. 6, fluid flow may be permitted between the fluid inlet 620 and the fluid outlet 622 through the valve channel 632. Accordingly, a fluid flow path F1 may be provided through the fluid inlet 620, the valve channel 632 and the fluid outlet 622 as indicated by the arrows in FIG. 6. The first fluid flow path F1 may extend in the first direction through the valve channel 632 when the check valve 618 is in the check valve OPEN position.

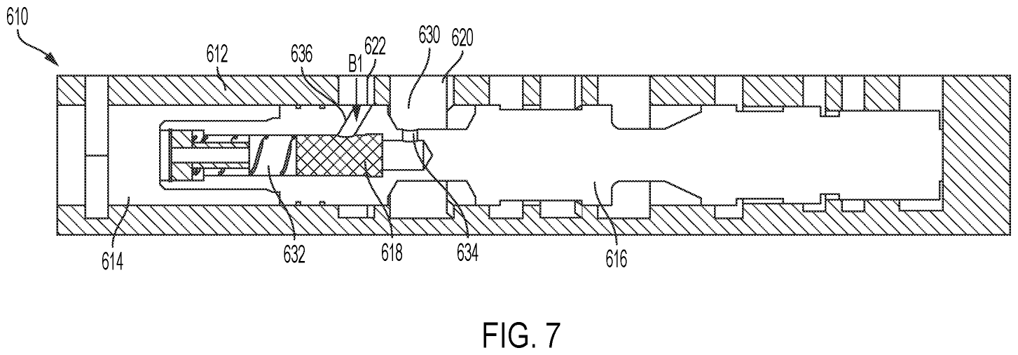

In an embodiment, the check valve 618 may be disposed completely with the valve piston 616. In an embodiment, the valve channel 632 may include a first opening 634 (FIG. 7) to receive fluid from the inlet opening 620. The first opening 634 may extend through at least a portion of a thickness of the valve piston 616. In an embodiment, the valve channel 632 may also include a second opening 636 (FIG. 7) configured to permit fluid flow from the valve piston 616 to the fluid outlet 622. The second opening 636 may extend through at least a portion of the thickness of the valve piston 616. In an embodiment, with the valve piston 616 in the CLOSED position, the first opening 634 may be at least partially aligned with one or more of the recess 630 and the fluid inlet 620, and the second opening 636 may be at least partially aligned with the fluid outlet 622.

In an embodiment, the check valve 618 may be in the check valve OPEN position (FIG. 6) when fluid pressure provided by the hydraulic pump is greater than the first fluid pressure. The check valve 618 may be in the check valve CLOSED condition when fluid pressure provided by the hydraulic pump is less than the first fluid pressure. That is, the check valve 618 may be moved between the check valve CLOSED position and the check valve OPEN position in response to a change in fluid pressure provided by the hydraulic pump to the pressure regulator valve assembly 610, when the change in fluid pressure either increases above or decreases below the first fluid pressure. The first fluid pressure is less than the second fluid pressure.

FIG. 7 is a cross-sectional diagram illustrating the pressure regulator valve assembly 610 of FIG. 6, with the check valve 618 moved to the check valve CLOSED position, according to an embodiment. In the check valve CLOSED position, the check valve 618 may substantially limit or prevent fluid flow between the fluid inlet 620 and the fluid outlet 622 through the valve piston 616. For example, in an embodiment, in the check valve CLOSED position, the check valve 618 may substantially limit or prevent fluid flow between the first opening 634 and the second opening 636.

Moreover, with the valve piston 616 in the CLOSED position, the check valve 618 in the check valve CLOSED position may substantially limit or prevent backflow or drainage of fluid from the torque converter through the pressure regulator valve assembly 610 in the second direction. For example, in an embodiment, a fluid backflow path B1 from the torque converter may be closed by the check valve 618 in the valve channel 632.

In an embodiment, the valve piston 616 may be urged toward one of the OPEN position or the CLOSED position. For example, the valve piston 616 may be urged toward the CLOSED position by a spring. The valve piston 616 may be moved to the OPEN position when the fluid pressure is sufficient to overcome the spring force. Similarly, the check valve 618 may be urged toward one of the check valve OPEN position or the check valve CLOSED position. For example, the check valve 618 may be urged toward the check valve CLOSED position by a spring. The check valve 618 may be moved to the check valve OPEN position when the fluid pressure is sufficient to overcome the spring force.

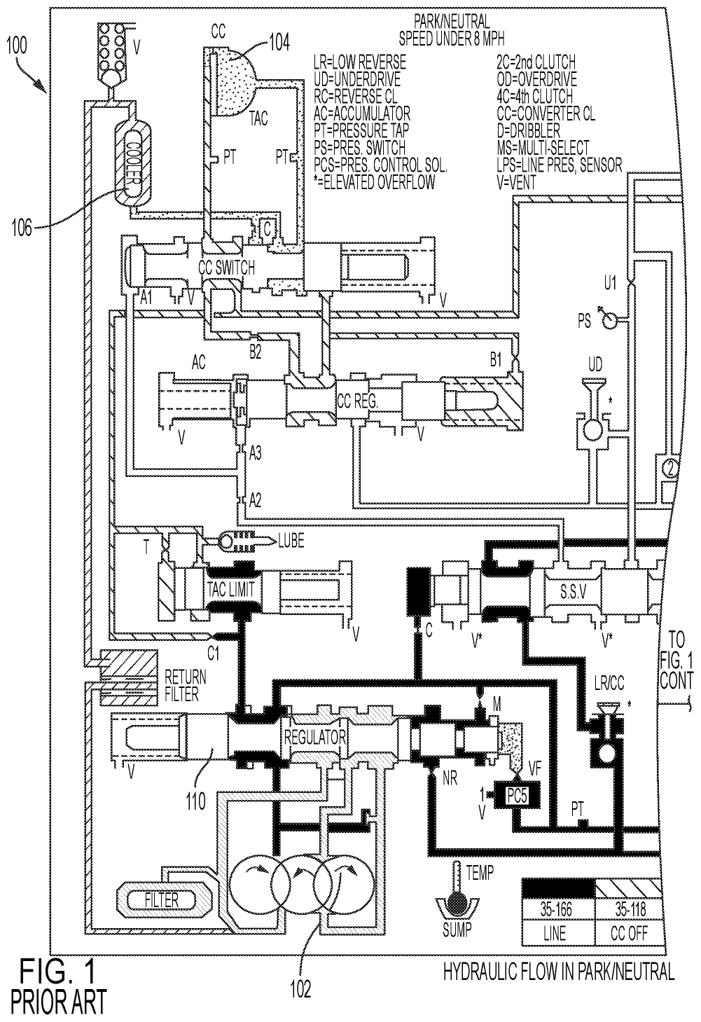

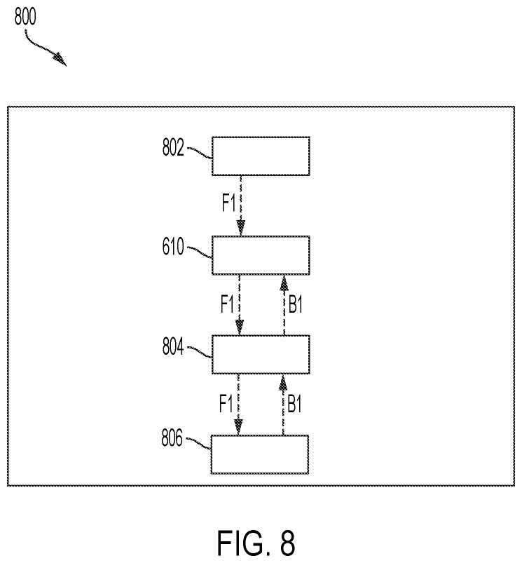

FIG. 8 is a schematic diagram illustrating an example of an automatic transmission 800 according to an embodiment. The automatic transmission 800 may generally include a hydraulic pump 802, a torque converter 804, a fluid cooler 806 and the pressure regulator valve assembly 610 of the present embodiments disposed between the hydraulic pump 802 and the torque converter 804. The automatic transmission 800 may be a known or OE transmission, such as a Chrysler RFE series automatic transmission, except that a known pressure regulator valve assembly is replaced by the pressure regulator valve assembly 610. Accordingly, the hydraulic pump 802, the torque converter 804 and the fluid cooler 806 may be any known, suitable hydraulic pump, torque converter and fluid cooler, such as those shown in FIG. 1 and/or included in the OE automatic transmission.

The fluid flow path F1 is shown extending from the hydraulic pump 802 to the torque converter 804 through the pressure regulator valve assembly 610. Fluid flow may be provided to the torque converter 804 and the fluid cooler 806 generally when the hydraulic pump 802 operates to provide fluid pressure higher than the first fluid pressure. A fluid backflow path B1 is also shown from the torque converter 804 to the pressure regulator valve assembly 610, where the fluid backflow path B1 may be closed by the check valve 618 described above and shown in FIG. 7. Fluid flow may be provided from the torque converter 804 to the pressure regulator valve assembly 610, for example, when the hydraulic pump is turned off or operated such that fluid pressure is less than the first fluid pressure.

Accordingly, in embodiments herein, the pressure regulator valve assembly 610 may be configured to permit a first fluid flow volume to the torque converter when the valve piston 616 is in the CLOSED position and the check valve 618 is in the check valve OPEN position. The valve piston 616 may be in the CLOSED position and the check valve 618 may be in the check valve OPEN position, for example, when the vehicle engine is operating in a relatively low RPM range, such as when the automatic transmission is in PARK or NEUTRAL (or DRIVE, in some instances). In the present embodiments, the first fluid flow volume may be greater than a fluid flow volume provided to the OE torque converter through the OE pressure regulator valve assembly 210 or known aftermarket pressure regulator valve assembly 510 in the CLOSED condition (i.e., with a valve piston in the CLOSED position).

The pressure regulator valve assembly 610 may be configured to provide a second fluid flow volume to the torque converter when the valve piston 616 is moved to the OPEN position. The valve piston 616 may be moved to the OPEN position, for example, when the vehicle engine is operating in a relatively high RPM range, such as when the automatic transmission is in DRIVE.

The pressure regulator valve assembly 610 according to embodiments herein may be configured to substantially limit or prevent backflow or draining of fluid from the torque converter when the valve piston 616 is in the CLOSED position and the check valve 618 is in the check valve CLOSED position. The check valve 618 may substantially limit or prevent backflow or drainage of fluid from the torque converter when the vehicle engine is turned off. Accordingly, a volume of fluid may remain in the torque converter while the vehicle engine is off and thus may allow for proper or improved functioning of the torque converter at startup of the vehicle engine.

It is understood that the features described with respect to any of the embodiments above may be implemented, used together with, or replace features described in any of the other embodiments above. It is also understood that description of some features may be omitted in some embodiments, where similar or identical features are discussed in other embodiments.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular. In addition, in is understood that terminology referring to directions or relative orientations, such as, but not limited to, “upper” “lower” “raised” “lowered” “top” “bottom” “above” “below” “alongside” “left” and “right” are used for purposes of example and do not limit the scope of the subject matter described herein to such orientations or relative positioning.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A pressure regulator valve assembly for an automatic transmission, the pressure regulator valve assembly comprising:
a valve body;
a valve chamber within the valve body;
a valve piston disposed within the valve chamber, the valve piston having a valve channel; and
a check valve disposed within the valve channel,
wherein the check valve is operable to permit fluid flow in the valve channel in a first direction and substantially prevent fluid flow in the valve channel in a second direction opposite to the first direction.

2. The pressure regulator valve assembly of claim 1, wherein the valve body includes a fluid inlet and a fluid outlet.

3. The pressure regulator valve assembly of claim 2, wherein the fluid inlet and the fluid outlet are fluidically connected via the valve channel.

4. The pressure regulator valve assembly of claim 2, wherein the valve channel includes a first opening and a second opening.

5. The pressure regulator valve assembly of claim 4, wherein the first opening is at least partially aligned with the fluid inlet and the second opening is at least partially aligned with the fluid outlet.

6. An automatic transmission comprising:
a hydraulic pump;
a torque converter; and
a pressure regulator valve assembly disposed between the hydraulic pump and the torque converter and configured to control fluid flow between the hydraulic pump and the torque converter, the pressure regulator valve assembly comprising:
a valve body;
a valve chamber within the valve body;
a valve piston disposed within the valve chamber, the valve piston having a valve channel; and
a check valve disposed within the valve channel,
wherein the check valve is operable to permit fluid flow in the valve channel in a first direction from the hydraulic pump to the torque converter and substantially prevent fluid flow in the valve channel in a second direction from the torque converter to the hydraulic pump.

7. The automatic transmission of claim 6, wherein the valve body includes a fluid inlet configured to receive fluid flow from the hydraulic pump and a fluid outlet configured to permit fluid flow to the torque converter.

8. The automatic transmission of claim 6, wherein the fluid inlet and the fluid outlet are fluidically connected via the valve channel.

9. The automatic transmission of claim 6, wherein the valve channel includes a first opening and a second opening.

10. The automatic transmission of claim 6, wherein the first opening is at least partially aligned with the fluid inlet and the second opening is at least partially aligned with the fluid outlet.
